(19) United States
(12) Patent Application Publication
(10) Pub. No.: US 2008/0238314 A1
(43) Pub. Date: Oct. 2, 2008

(54) PLASMA DISPLAY PANEL

(76) Inventor: Jin-man Jeoung, Suwon-si (KR)

Correspondence Address: CHRISTIE, PARKER & HALE, LLP, PO BOX 7068, PASADENA, CA, 91109-7068, US

(21) Appl. No.: 11/948,941

(22) Filed: Nov. 30, 2007

(30) Foreign Application Priority Data
Mar. 27, 2007 (KR) 10-2007-0029836

(51) Int. Cl. H01J 17/49

(52) U.S. Cl. 313/582

(57) ABSTRACT

A plasma display panel capable of reducing (or preventing) image quality deterioration due to light transmission of a rear substrate. In one embodiment, a plasma display panel has a discharge space and includes a front substrate module, a rear substrate module opposing the front substrate module, and a barrier rib between the front substrate module and the rear substrate module. Here, the rear substrate module includes a rear substrate; an electrode on the rear substrate; a rear dielectric layer on the electrode; a dielectric adding layer on the rear dielectric layer and including a material having a different light transmission property than the rear dielectric layer; and a phosphor layer on the dielectric adding layer and the barrier rib and facing the discharge space.

### CROSS-REFERENCE TO RELATED APPLICATION

This application claims priority to and the benefit of Korean Patent Application No. 10-2007-0029836, filed on Mar. 27, 2007, in the Korean Intellectual Property Office, the entire content of which is incorporated herein by reference.

### BACKGROUND OF THE INVENTION

1. Field of the Invention

The present invention relates to a plasma display panel and a rear substrate module thereof.

2. Discussion of Related Art

FIG. 1 shows a cross-sectional structure of a unit cell of a plasma display panel 10.

Referring to the FIG. 1, the plasma display panel 10 is provided with a pair of sustain electrodes 25, having a width and a height, formed on the same surface of a front substrate 21, and a front dielectric layer 26 is formed on the sustain electrodes 25 by using a printing method. A protective film layer 27 is formed over the front dielectric layer 26.

An address electrode 32 having a width and a height is formed on a rear substrate 31 installed to be opposed to the front substrate 21, and a barrier rib 36 is formed in order to reduce (or prevent) cross-talk between the adjacent discharge cells generated from the address electrode 32. A rear dielectric layer 33 is formed on the rear substrate 31 to protect the address electrode 32. A phosphor layer 35 is formed on the upper surface of the address electrode 32 and the side wall of the barrier rib 36.

In addition, the inner space, where the front and rear substrates 21 and 31 are coupled, is filled with inert gas so that a discharge region 39 is formed.

In the above structure, if a driving voltage is applied to the sustain electrodes 25, surface discharge occurs in the discharge region on the surface of the front dielectric layer 26 and the protective film layer 27 so that ultra violet rays are generated. The phosphor material of the surrounding phosphor layer 35 is excited by the generated ultra violet rays to display a light (e.g., a light with a color).

### SUMMARY OF THE INVENTION

An aspect of an embodiment of the present invention is directed to a plasma display panel capable of reducing (or preventing) light leakage into a rear substrate of the plasma display panel.

Another aspect of an embodiment of the present invention is directed to a plasma display panel capable of reducing (or preventing) light leakage into a rear substrate of the plasma display panel and of being manufactured at low manufacturing expenses.

Another aspect of an embodiment of the present invention is directed to a plasma display panel capable of reducing reflection of external light, while reducing (or preventing) light leakage into a rear substrate of the plasma display panel.

Another aspect of an embodiment of the present invention is directed to a plasma display panel capable of reducing (or preventing image) quality deterioration due to light leakage of a rear substrate of the plasma display panel.

In an embodiment of the present invention, a plasma display panel includes: a rear substrate; an additional structure formed on the rear substrate; a first rear dielectric layer covering (or burying) the additional structure; a second rear dielectric layer formed of dielectric material having different light transmission property than that of the first rear dielectric layer; and a phosphor layer covering the second rear dielectric layer and facing a partitioned discharge space.

In another embodiment of the present invention, a plasma display panel has a discharge space and includes a front substrate module, a rear substrate module opposing the front substrate module, and a barrier rib between the front substrate module and the rear substrate module. Here, the rear substrate module includes a rear substrate; an electrode on the rear substrate; a rear dielectric layer on the electrode; a dielectric adding layer on the rear dielectric layer and including a material having a different light transmission property than that of the rear dielectric layer; and a phosphor layer on the dielectric adding layer and the barrier rib and facing the discharge space.

In another embodiment of the present invention, a plasma display panel includes a substrate; an address electrode on the substrate; a first dielectric layer on the address electrode; a second dielectric layer on the first dielectric layer and including a material having a different light transmission property than that of the first dielectric layer; and a phosphor layer on the second dielectric layer and the barrier rib.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a cross-sectional schematic view showing a structure of a unit cell of a plasma display panel.

FIG. 2 is a cross-sectional schematic view showing a structure of a unit cell of a plasma display panel according to an embodiment of the present invention.

FIGS. 3A, 3B, and 3C are concept views for illustrating total reflection of light on an interface of materials having different refractive indexes.

FIG. 4 is a perspective schematic view showing a structure of a plasma display panel according to an embodiment of the present invention.

### DETAILED DESCRIPTION

Hereinafter, exemplary embodiments according to the present invention will be described with reference to the accompanying drawings. Here, when one element is described as being connected to another element, one element may be not only directly connected to another element but instead may be indirectly connected to another element via one or more other elements. Also, in the context of the present application, when an element is referred to as being “on” another element, it can be directly on the another element or be indirectly on the another element with one or more intervening elements interposed therebetween. Further, some of the elements that are not essential to the complete description of the invention have been omitted for clarity. Also, like reference numerals refer to like elements throughout.

Referring back to FIG. 1, in the plasma display panel 10, a portion of light generated due to the excitation of the phosphor material leaks through the rear substrate 31 as shown by the arrows in FIG. 1 so that the luminous efficiency is deteriorated by the leaked light.

To block the leaked light, the light generated from the inside of a plasma display panel has currently been blocked by a rear reflective film, but, to some extent, light would still leak through the rear reflective film. In addition, if such leaked light can be sent to the front substrate again, it can greatly improve the brightness and efficiency of the plasma display panel; however, the expenses in the manufacturing process thereof should not be increased too much.

A plasma display panel according to an embodiment of the present invention is directed to a rear dielectric layer of a rear substrate module. Here, unlike the plasma display panel 10 of FIG. 1, which has the single dielectric layer 33 for burying the address electrode 32 between the rear substrate 31 and the phosphor layer 35, the plasma display panel according to the embodiment of the present invention has a double-layer structure formed of material having different light transmission property.

Designs (or schemes) of a double-layer structure according to embodiments of the present invention are described in more detail below.

In a first design (or scheme), the double-layer structure is formed of one or more materials having different light transmission properties so that it can reflect a considerable amount of light leaked toward a rear substrate back to a front substrate by using total reflection of light on an interface of the materials having different refractive indexes.

In a second design (or scheme), the double-layer structure is formed by a second dielectric layer covering an upper surface of a first dielectric layer for burying an address electrode with light transmitting material colored for subtractive mixture so that it can reduce reflection of external light. In this scheme, the double-layer structure is formed of materials having the properties of the first and second schemes so that it can simultaneously accomplish the effects of the first and second schemes.

In the first and second schemes, although the layer covering the upper surface of the first dielectric layer for covering (or burying) the address electrode in the double-layer structure can be implemented by a light transmitting material that is not dielectric, an embodiment of the present invention uses a transmitting dielectric layer for the layer covering the upper surface of the first dielectric layer in order to reduce time and expense in view of manufacturing process and effects as a dielectric.

In a third design (or scheme), the double-layer structure is formed by a reflective thin film layer having a light reflective property on the upper surface of the first dielectric layer for burying the address electrode so that it can reflect a considerable amount of light leaked toward a rear substrate back to a front substrate.

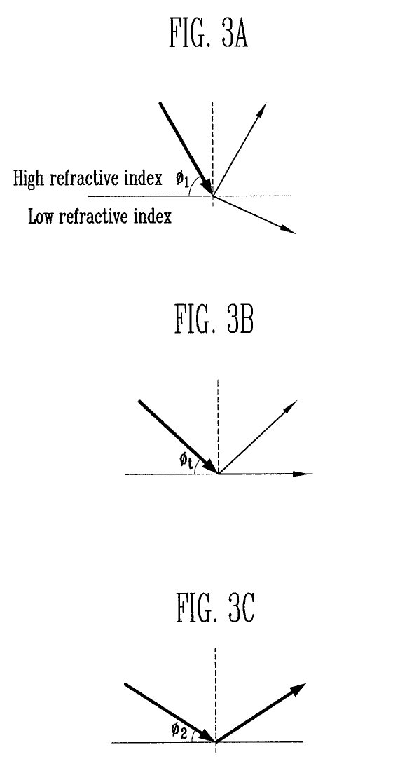

Hereinafter, embodiments according to the present invention will be described in more detail with reference to FIGS. 3 to 6. The following embodiments are provided as examples of the present invention and should not limit the scope of the present invention

### EMBODIMENT

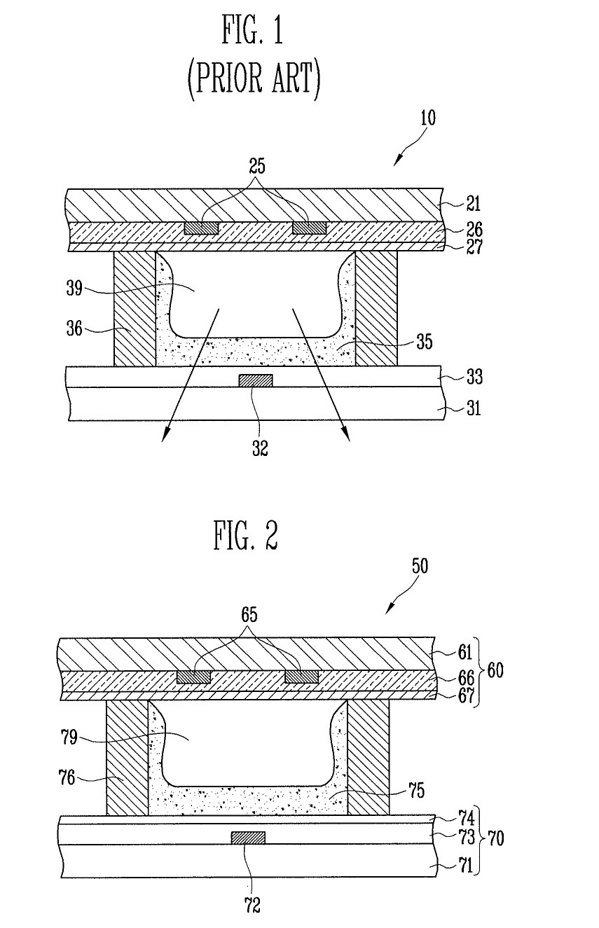

FIG. 2 shows a cross-sectional structure of a unit cell of a plasma display panel 50 according to an embodiment of the present embodiment.

Referring to the FIG. 2, the plasma display panel 50 according to the present embodiment includes a front (or first) substrate module 60, a rear (or second) substrate module 70 opposing the front substrate module 60, and a barrier rib (or ribs) 76 for maintaining an interval between the two substrate modules. Here, the plasma display panel 50 is formed to have a discharge space 79 by filling the inner space between the front substrate module 60 and rear substrate module 70, which are coupled to each other with the barrier rib 76, with an inert gas.

The front substrate module 60 is provided with a front (or first) substrate 61, a pair of sustain electrodes 65 having a width and a height on the same surface of the front substrate 61, and an upper dielectric layer 66 for burying the sustain electrodes 65. A protective film layer 67 is formed on the upper dielectric layer 66.

The rear substrate module 70 is provided with a rear (or second) substrate 71 installed to be opposed to the front substrate 61 and an address electrode 72 having a width and a height formed on the rear substrate 71. The barrier rib 76 is formed in order to reduce (or prevent) cross-talk between the adjacent discharge cells generated from the address electrode 72, wherein a phosphor layer 75 is formed on the upper surface of the address electrode 72 and the side wall of the barrier rib 76. Here, a first rear dielectric layer 73 for protecting the address electrode 72 is formed on the rear substrate 71, a second rear dielectric layer 74 is formed on the first rear dielectric layer 73, and the phosphor layer 75 is positioned on the second rear dielectric layer 74.

The phosphor layer 75 also has reflective index with a value that may be predetermined, wherein in view of the refractive indexes of the phosphor layer 75, the second rear dielectric layer 74, and the first rear dielectric layer 73, the phosphor layer 75 has the largest value, and the second rear dielectric layer 74 has a value larger than that of the first rear dielectric layer 73 (i.e., the first rear dielectric layer 73 has the smallest value).

FIGS. 3A to 3C show a total reflection phenomenon on an interface of materials having different refractive indexes, wherein the light progressing from medium having high refractive index to medium having low refractive index is totally reflected when the incident angle φ₂ to the interface becomes below a critical angle φₜ as shown in FIG. 3C (wherein the critical angle φₜ may be predetermined), and considerable parts of the light incident at an angle φ₁ above the generation of the total reflection are also reflected as shown in FIG. 3A.

The second rear dielectric layer 74 of the present embodiment is a medium having a higher refractive index value as compared to that of the first rear dielectric layer 73 so that the light leaked from the discharge space 79 to the rear substrate 71 becomes the light incident from the medium having the high refractive index to the medium having low refractive index. Therefore, considerable parts of the leaked light are reflected on the interface between the second rear dielectric layer 74 and the first rear dielectric layer 73 to be progressed toward the front substrate 61. This reflection relationship is again presented between the phosphor layer 75 and the second rear dielectric layer, where the phosphor layer 75 has a higher refractive index value than that of the second rear dielectric layer 74.

Also, in one embodiment, the first rear dielectric layer 73 is formed to be thicker than the second rear dielectric layer 74 and of a dielectric material capable of improving a burial effect of the address electrode 72 in plasma discharge.

Also, in one embodiment, the first rear dielectric layer 73 and/or the second rear dielectric layer 74 are colored for subtractive mixture. In one embodiment, in view of manufacturing efficiency, the second rear dielectric layer 74 is colored (because the second rear dielectric layer 74 is more open or freer to the kind of materials that it can be made from).

Various suitable coloring methods for the subtractive mixture may be employed. Among them, two methods will be described as examples.

The first method is to reduce (or prevent) reflection of external light due to the address electrode 72 buried in the first rear dielectric layer 73, other circuit devices, and/or other components. To this end, the second rear dielectric layer 74 is colored with the color in the relation of complementary colors with color of reflection light of the component for reducing (or preventing) the reflection of external light due to the address electrode 72, etc. As such, e.g., during non-emission, the reflection of external light due to the address electrode 72, etc. toward the front substrate module 60 is efficiently reduced (or prevented).

The second method is to have the relation of subtractive mixture in the relation with the front substrate module 60. To this end, parts (for example, the front substrate 61, the upper (or front) dielectric layer 66 and/or the protective film layer 67) of the components of the front substrate module 60 are colored. In this case, the color colored on the front substrate module 60 may be determined to be in the relation of complementary colors with color of the barrier rib 76 etc., so that it can reduce (or prevent) the reflection of external light due to the barrier rib, etc. Here, the colors colored on the second rear dielectric layer 74 are determined depending on the relation of complementary colors with colors colored on the front substrate module 60. Then, most light transmitting from the second rear dielectric layer 74 can be blocked by the front substrate module 60, making it possible to reduce (or prevent) the reflection of external light due to the second rear dielectric layer 74 or the lower structure thereof.

The composition of the rear dielectric layers 73 and 74 having the different refractive indexes can be selected from two dielectric materials having an optimal reflection condition by adding quartz-based silica+GeO₂ or P₂O₅, silica+F or B₂O₃, sodalime silica, boron silicate, alumina silicate, alkali germano silicate, sapphire, BaTiO₃, LiNbO₃, MgO, Magnesia spinel, etc. into an existing lower dielectric material.

Hereinafter, the ingredient composition of the first rear dielectric layer and the second rear dielectric layer according to one embodiment of the present invention will be described in more detail below.

Here, the composition of the rear dielectric includes TiO₂ that is added into parent glass composed of PbO—SiO₂—R₂O₃—Al₂O₃ as a filler. When the embodiment of the present invention is applied to the above general composition of the rear dielectric, the ratio of the PbO—SiO₂—R₂O₃—Al₂O₃—TiO₂ may be implemented to have a value of 100:12 for the first rear dielectric layer 73; and the ratio of the PbO—SiO₂—R₂O₃—Al₂O₃—TiO₂ may be implemented to have a value ranging from 100:5 to 100:10 for the second rear dielectric layer 74. Also, in this case, a small amount of MgO may be added to the parent glass, wherein the addition rate of MgO has a value that is substantially less than that of the TiO₂.

Also, by removing harmful Pb material from the composition, a lead-free-based glass, such as Bi-based glass and B₂O₃-based glass, may be used as the parent glass of the first rear dielectric layer 73 and the second rear dielectric layer 74. In other words, a small amount of alkali material is added into basic composition of Bi₂O₃—B₂O₃—ZnO—SiO₂ instead of the PbO—SiO₂—R₂O₃—Al₂O₃ or a small amount of alkali material is added into basic composition of BaO—B₂O₃—ZnO—SiO₂ as the parent glass. Here, the addition rate of the TiO₂ or MgO may be the same (or substantially the same) as the case of the parent glass of PbO—SiO₂—R₂O₃—Al₂O₃.

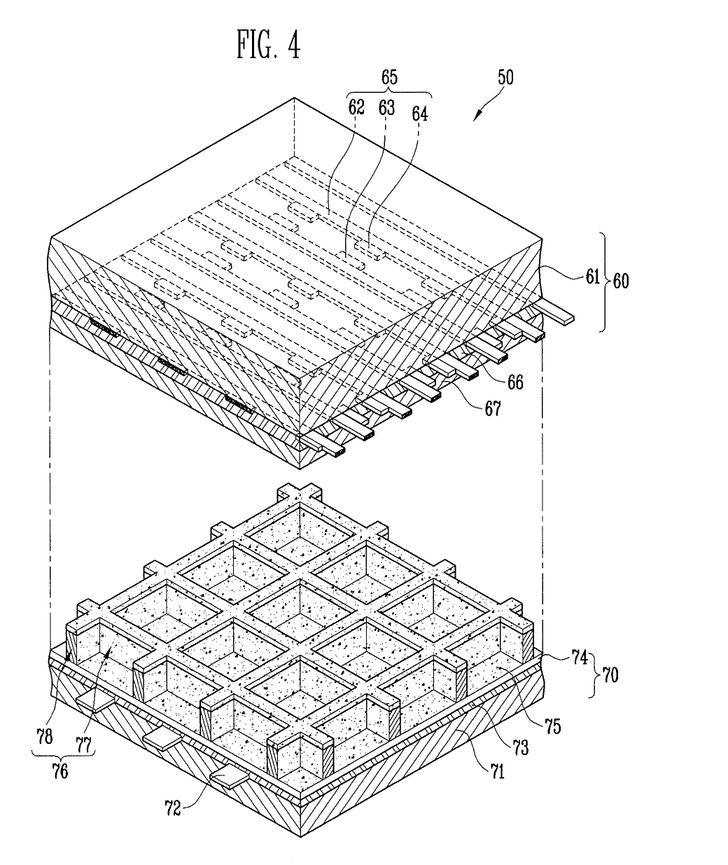

FIG. 4 shows a plasma display panel 50 having the unit cell structure as shown in FIG. 2.

Referring to FIG. 4, the plasma display panel 50 is provided with the front substrate 61 and the rear substrate 71 disposed to be opposed to (or to face) the front substrate 61.

Bus electrodes 62 are disposed to be spaced at an interval that may be predetermined on the lower surface of the front substrate 61. The bus electrode 62 is formed in a strip shape. The sustain electrode 65 formed (or constituted) by a common electrode 63 and a scan electrode 64 having a size (that may be predetermined) is protruded to a direction opposed to each other from one side wall of the inner side of the pair of bus electrodes 62.

The sustain electrode 62 is disposed to be spaced at an interval (that may be predetermined) along one side wall of the bus electrode 62, and the region, where the opposed common electrode 63 and scan electrode 64 are formed, forms one discharge cell. Also, the region between the pair of bus electrodes 62 where the common and scan electrodes 63 and 64 forming the discharge cell are disposed and the other pair of bus electrodes 62 adjacent thereto corresponds to a non-discharge region.

Such common and scan electrodes 63 and 64 are formed of an indium tin oxide (ITO) film, which is a transparent conductive film. In one embodiment, the bus electrode 62 is patterned by using a silver paste.

The lower surface of the front substrate 61, on which the bus electrodes 62 and the sustain electrode 65 are formed, is provided with the upper (or front) dielectric layer 66 for covering (or burying) the bus electrodes 62 and the sustain electrode 65. The lower surface of the upper (or front) dielectric layer 66 is applied (or entirely applied) with the protective film layer 67, such as a oxidation magnesium film.

The upper surface of the rear substrate 71 is provided with the address electrodes 72 spaced at an interval. The address electrodes 72 are disposed in the direction crossing (or orthogonal to) the direction that the bus electrodes 62 are formed. The address electrodes 72 are positioned in the discharge cells on the part where the common and scan electrodes 63 and 64 are opposed. The first rear dielectric layer 73 for covering (or burying) the address electrodes is formed on the upper surface of the address electrodes 72, and the second rear dielectric layer 74 is formed on the first rear dielectric layer 73.

The upper surface of the second rear dielectric layer 74 is provided with the barrier rib 76 for partitioning the discharge space and for reducing (or preventing) a cross-talk. The barrier rib 76 can include a first barrier rib 77 formed in the direction parallel to the bus electrode 62, and a second barrier rib 78 formed in the direction crossing (or orthogonal to) the bus electrode 62 and parallel to the address electrode 72. The second barrier rib 78 is extended from and/or to both side walls of the first barrier rib 77 and integrally connected thereto to form the barrier rib 76 that is of a lattice type. According to implementations, the barrier rib 76 can be formed into other suitable types for partitioning the discharge space such as a meander type or a strip type, etc., rather than the lattice type.

The inner side wall of the barrier rib 76 and the upper surface of the second rear dielectric layer 74 are provided with red, greed, and blue phosphor layers in correspondence with the discharge cells.

The plasma display panel 50 according to the present embodiment having the above structure reflects light generated from the discharge space and leaked toward the rear substrate 71 back to the front substrate 61 depending on the total reflection of the first rear dielectric layer 73 and the second rear dielectric layer 74, and/or colors the second rear dielectric layer 74 with color in the relation of subtractive mixture to reduce (or prevent) the reflection of external light due to the lower structure thereof.

In the above embodiment, as the upper surface of the first rear dielectric layer 73 is covered with the second rear dielectric layer 74 having different refractive index, the case that the first and second schemes of the present invention colored for subtractive mixture are simultaneously implemented is specifically described.

However, the plasma display panels implementing only the first scheme or the second scheme of the present invention can also be easily inferred from the explanation of the above embodiment.

Also, according to the third scheme of the present invention, a reflective thin film layer can be formed to contact with the upper surface of the first rear dielectric layer 73 as shown in FIG. 2. In this case, the reference numeral 74 in FIG. 2 represents a reflective thin film layer.

In this case, due to the existence of the reflective thin film layer 74, the light leaked to the rear substrate 71 is reflected so that it can be emitted from (or provided to) the front substrate 61. Also, to reduce (or prevent) the reflection of external light due to the reflective thin film layer 74, e.g., during non-emission, embodiments of the present invention color the front substrate module with color 60 in the complementary relation with the color of the reflective thin film layer 74.

An embodiment of the present invention adopts the PDP front substrate module and rear substrate module having any suitable structure, and applies a second dielectric layer having different refractive index on the existing rear substrate dielectric layer to reduce an additional processing cost.

Furthermore, an embodiment of the present invention is effective in contributing to the improvement of brightness and efficiency of a PDP by reflecting the light leaked toward the rear substrate back to be transmitted through the front substrate.

Also, an embodiment of the present invention is capable of suppressing the reflection of external light by applying the effective complementary relation of the subtractive mixture for the part of the rear dielectric layer.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A plasma display panel having a discharge space and including a front substrate module, a rear substrate module opposing the front substrate module, and a barrier rib between the front substrate module and the rear substrate module, the rear substrate module comprising:
a rear substrate;
an electrode on the rear substrate;
a rear dielectric layer on the electrode;
a dielectric adding layer on the rear dielectric layer and comprising a material having a different light transmission property than that of the rear dielectric layer; and
a phosphor layer on the dielectric adding layer and the barrier rib and facing the discharge space.

2. The plasma display panel as claimed in claim 1, wherein the phosphor layer has a refractive index larger than that of the rear dielectric layer.

3. The plasma display panel as claimed in claim 1, wherein the phosphor layer has a refractive index larger than that of the dielectric adding layer.

4. The plasma display panel as claimed in claim 1, wherein the dielectric adding layer is a reflective thin film layer.

5. The plasma display panel as claimed in claim 1, wherein the dielectric adding layer has a color in complementary relation with an appearance color of the electrode.

6. The plasma display panel as claimed in claim 1, wherein the dielectric adding layer has a color in complementary relation with a transmission color of the front substrate module.

7. The plasma display panel as claimed in claim 1, wherein the rear dielectric layer comprises TiO₂ and a first parent glass and a ratio of the first parent glass to the TiO₂ is 100:12, and wherein the dielectric adding layer comprises TiO₂ and a second parent glass and a ratio of the second parent glass to TiO₂ ranges from 100:5 to 100:10.

8. The plasma display panel as claimed in claim 7, wherein the rear dielectric layer and/or the dielectric adding layer comprises MgO.

9. The plasma display panel as claimed in claim 7, wherein the first parent glass and/or the second parent glass comprise Bi₂O₃—B₂O₃—ZnO—SiO₂.

10. The plasma display panel as claimed in claim 7, wherein the first parent glass and/or the second parent glass comprise PbO—SiO₂—R₂O₃—Al₂O₃.

11. The plasma display panel as claimed in claim 7, wherein the first parent glass and/or the second parent glass comprise BaO—B₂O₃—ZnO—SiO₂.

12. The plasma display panel as claimed in claim 1, wherein the dielectric adding layer has a refractive index larger than that of the rear dielectric layer.

13. The plasma display panel as claimed in claim 12, wherein the phosphor layer has a refractive index larger than that of the dielectric adding layer.

14. A plasma display panel comprising:
a substrate;
an address electrode on the substrate;
a first dielectric layer on the address electrode;
a second dielectric layer on the first dielectric layer and comprising a material having a different light transmission property than that of the first dielectric layer; and
a phosphor layer on the second dielectric layer and the barrier rib.

15. The plasma display panel as claimed in claim 14, wherein the second dielectric layer has a refractive index larger than that of the first dielectric layer.

16. The plasma display panel as claimed in claim 14, wherein the phosphor layer has a refractive index larger than that of the second dielectric layer.

17. The plasma display panel as claimed in claim 14, wherein the second dielectric layer is a reflective thin film layer.

18. The plasma display panel as claimed in claim 14, wherein the second dielectric layer has a color in complementary relation with an appearance color of the anode electrode

19. The plasma display panel as claimed in claim 14, further comprising:
a front substrate facing the substrate,
a plurality of sustain electrodes on the front substrate;
a third dielectric layer on the sustain electrodes; and
a protective film on the third dielectric layer,
wherein the second dielectric layer has a color in complementary relation with a transmission color of the front substrate, the sustain electrodes, the third dielectric layer or the protective film.

20. The plasma display panel as claimed in claim 14, wherein the first dielectric layer comprises TiO₂ and a first parent glass and a ratio of the first parent glass to the TiO₂ is 100:12, and wherein the second dielectric layer comprises TiO₂ and a second parent glass and a ratio of the second parent glass to TiO₂ ranges from 100:5 to 100:10.
